(19) United States
(12) Patent Application Publication
(10) Pub. No.: US 2022/0107512 A1
(43) Pub. Date: Apr. 7, 2022

(54) Sports eyewear

(71) Applicant: UK OPTICAL PLASTICS LIMITED, Leicester Leicestershire (GB)

(72) Inventor: ANTONIE MESSIOU, Leicester (GB)

(21) Appl. No.: 17/644,086

(22) Filed: Dec. 13, 2021

Related U.S. Application Data
(63) Continuation of application No. PCT/CN2019/051643, filed on Jun. 13, 2019.

(51) Int. Cl. G02C 7/16; G02C 11/00

(52) U.S. Cl. CPC G02C 7/16; G02C 11/12

(57) ABSTRACT

An article of eyewear comprises a shade 4 that may be worn independently or attached to the frame 3 of spectacles or sunglasses. The shade 4 is shaped and positioned not to obscure the field of view of the wearer when looking straight ahead but to obscure the field of view of the wearer when looking either upwards or downwards, apart from in the areas of two unobscured apertures 8 formed as slots from the edge of the shade 4. If the shade 4 is above the field of view, it permits a player of a racquet sport such as tennis to see the ball during a serve or other overhead shot, while being shielded from the glare of surrounding overhead light. If the shade 4 is below the field of view, it permits a skier to view the piste below, while being shielded from the glare of the surrounding snow. The two apertures 8 may be aligned to converge on a fixation point a metre away or many metres away respectively for racquet sports or for downhill skiing.

### CROSS-REFERENCE TO RELATED APPLICATIONS

This application is a continuation of International Patent Application Number PCT/GB2019/051643, filed on Jun. 13, 2019, the disclosure of each of which is incorporated herein by reference and on each of which priority is hereby claimed.

### DESCRIPTION

### Technical Field

The invention relates to improved eyewear for racquet and other sports that are played inside or outside under bright lighting conditions.

### Background

It is often the case that in sports played outside such as tennis, bright sunlight can impair the tennis player's vision, cause discomfort, persistence of vision and in some situations cause temporary blindness. Such impairment can also occur indoors where the lighting is provided by bright floodlights. The impairment to a player's vision can reduce his or her performance and can potentially be hazardous. In racquet sports such as tennis and badminton the situation with greatest potential for such blinding effect is in overhead shots and overhead serves. The same problem may arise in other sports played in sunny conditions, for example when a cricket or baseball player attempts to catch a high ball. A clay pigeon shooter similarly has to focus on a small target seen against a bright sky.

In other sports such as downhill skiing, a clear view of the piste below the skier is essential for his or her safety. In bright sunshine, reflected glare from snow can be directed back into the skier's eyes. Such glare can impair the skier's view of the piste. A motorist may face similar conditions when attempting to focus on the road ahead, while driving towards a low sun or brightly lit sky.

Prior to the current invention various solutions to this problem have been employed including the use of partially opaque lenses or photochromic lenses (Reactolite® being one trade name example), polarizing filters, gradient index filters or lenses with a reflective coating. Such arrangements offer limited solutions but generally operate as partially attenuating filters over the whole visual field of view. Clearly when the eyes are looking down or away from the general direction of sunlight or intense light such solutions are disadvantageous because the external scene is typically dimmer than it needs to be.

### The Invention

The invention provides an article of eyewear comprising a shade as defined in claim 1. Preferred but non-essential features of the invention are defined in the dependent claims.

The proposed solution affords reduced glare in specific directions of the wearer's field of view corresponding to the “fixation point” of the wearer's gaze (such as ball position when serving in tennis) whilst at the same time leaving the field of view in other gaze directions unaffected. In addition, the proposed invention provides an uninterrupted view when the wearer's gaze direction moves to and from these specific fields. The desired fields of view are continuous and there is no visible demarcation or boundary between them.

The principle behind the invention is that the optical arrangement blocks out rays that originate a long distance away whilst allowing rays from objects that are at the wearer's fixation point to pass through un-attenuated. Indirect rays coining from above at oblique angles are also blocked. Because the invention selectively blocks undesirable rays from certain directions it has a secondary benefit in that fewer changes in the adaptation of the eye are required. This is because under bright illumination there is less background light level difference for the wearer between looking in different directions. When the eye is subjected to sudden high levels of light exposure, it takes time for the eye to adapt. In professional racquet sport and even in competitive amateur sport, even a few hundredths of a second in reaction time can make a significant competitive advantage. In sports such as downhill skiing and when driving towards a low sun, the proposed invention is advantageous as it affords increased safety to the user.

The proposed solution may comprise a separate block to be attached by clips to existing eyewear or glasses or it may be integral to the eyewear or glasses.

### THE DRAWINGS

FIGS. 1,1a and 1b respectively are a plan view, side view and a front view of eyewear that is novel but does not fall within the scope of the claimed invention but is useful for explaining the invention. In FIGS. 1 and 1a the eyewear is attached to sports glasses. Only the eyewear itself is shown in FIG. 1b.

FIGS. 2 and 2a respectively are a front view and plan view of eyewear according to a first embodiment of the invention.

FIG. 3 is a perspective view of eyewear according to a second embodiment of the invention, partially disassembled.

FIGS. 4 and 4a are respectively a front view and a plan of eyewear according to a third embodiment of the invention.

FIG. 5 is a perspective view of eyewear according to a fourth embodiment of the invention.

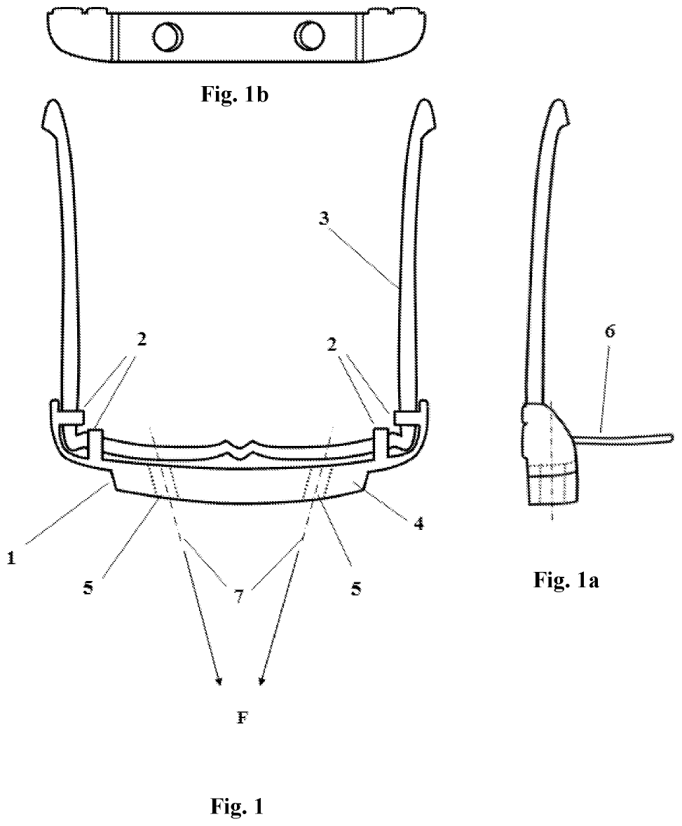

Referring to FIGS. 1,1a and 1b the proposed eyewear 1 is shown attached by integral clips 2 to sports glasses 3. An opaque main block 4 has viewing holes 5 in it shown as dotted lines. If the main block 4 is solid then the holes may be formed as tubular passages through the block. The internal surfaces of the tubes have a matte, light absorbing texture. Alternatively, to save weight and material, the main block 4 may be hollow, in which case each hole is defined by a pair of circular openings in the front and back walls of the block respectively. The diameter is typically 10 mm approximately.

Taking a hole diameter of 10 mm, a spacing of 20 mm between the front and back ends of the hole and 15 mm eye relief (i.e. the spacing between the rear wall of the main block 4 and the eyes) provides an approximate total field of view of 16 degrees. The field diameter at a distance of 1000 mm is 280 mm approximately. For tennis, where the ball diameter is 67 mm, this field diameter is appropriate. For smaller objects a slightly smaller field may be desirable and would be provided by employing smaller diameter holes ≤8 mm or by provision of longer holes. In practice, other factors affect the selection of a desirable hole diameter which conflict with the level of glare reduction. Glare reduction is increased when the hole diameter is reduced. However, the avoidance of a distracting visual “tunnel effect” is afforded by increasing the hole diameter. Also increasing the hole size helps ease of positioning tolerance of the main block 4 relative to the eyes and the inter-pupillary (IP) distance.

Another limitation of minimum hole size is set by the diameter of the human eye pupil. Typically the eye pupil in normal ambient lighting conditions is 4 to 8 mm diameter so the diameter of the holes nearest the eye should not be significantly less than 4 mm. The diameter of the holes furthest from the eye could be less than the diameter of the holes nearest the eye such that a tapered geometry is provided. Overall practical compromises are made on the selection of hole diameter, hole length, many of the parameters being determined by an individual player's viewing comfort requirements and his or her preferences for the level of glare reduction.

The vertical extent of the main block 4 is approximately ⅓ to ⅕ of the vertical extent of the lenses 6 such that the main visual field is not significantly affected. The lenses are hidden by the frame 3 in FIG. 1a and are not shown for the purpose of clarity. Viewing through spectacle lenses is done normally through the centre of the lens, when looking upwards where the neck is stretched, as for example when serving, it is actually more natural and comfortable for the eyes to view through the top portion of the spectacle lens. In this way the arrangement is advantageous in all viewing directions and the whole of the spectacle lenses are fully utilised. The lenses 6 are typically curved in an arc in plan view and may or may not have optical power. The arrangement works equally well when the frame 3 has no lenses 6 in it.

The centrelines 7 of the holes 5, in plan view are angled such that they converge and intersect at a fixation point F. The fixation point is arranged to coincide with the position of the ball or shuttlecock when in contact with the head of the racquet, being held with the player's arm extended for serves or overhead shots. Standard tennis and badminton racquet length should not exceed 737 mm and 680 mm respectively. Furthermore the distance from the centre of the hitting area of the racquet to the grip (hand) is around 430 mm. In addition if we take 450 mm as the distance between the eyes and the hand of an extended arm (ignoring for the moment gender differences) we can round up the distance between the eyes and the ball for serves as being 1 metre. Taking a typical average IP distance as 63 mm, the total angle subtended at point F by the centrelines 7 is approximately 3.6 degrees. A range between 1 and 5 degrees is enough to encompass a majority of anatomical variations in the sports player population. When the eyewear is manufactured, the spacing of the holes 7 nearest the eyes would be matched to the individual's IP distance. The centreline line convergence angle can also be adjusted or preset to the desired eye-to-ball distance for that particular individual. Universally adjustable holes for a range of IP and a range of hole centreline fixation angles are also envisaged.

Although the glare reduction characteristics are optimised for an individual's eye-to-ball distance for an overhead serve, the eyewear affords glare reduction for higher ball positions such as lobs in tennis. This is because of the shading effects of the material of the main block 4 around and close to the eyes as well as the holes themselves.

Although many of the features of the eyewear illustrated in these FIGS. 1, 1a and 1b are advantageous and useful for explanatory purposes, this version of it is not claimed as an embodiment of the invention because the holes create a demarcation that interrupts the field of view when the wearer's gaze moves from straight ahead to a second direction, such as upwards, looking through the holes.

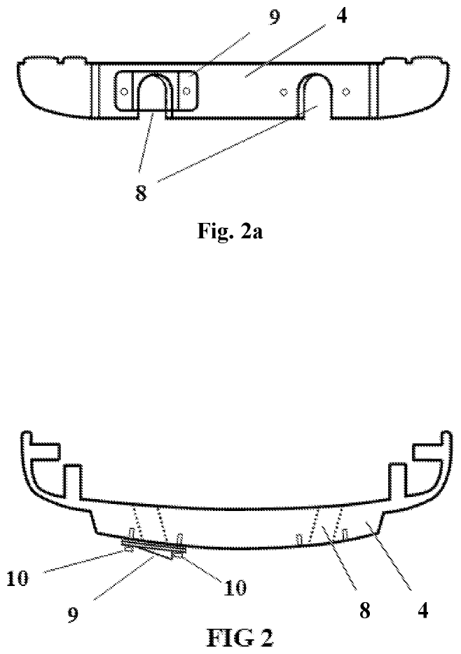

A preferred embodiment is shown in FIGS. 2 and 2a, where slots 8 are incorporated in the underside of the main block 4 instead of tubular holes. The centreline angles of the slots 8 in plan view are as indicated in the previous embodiment. The slot width is typically namely 4 to 10 mm approximately. The minimum practical width limit is 4 mm since a typical average pupil diameter in bright conditions is at least 4 mm. A smaller slot width would disrupt the wearer's view and be visually uncomfortable. The width of the slots furthest from the eye may be less by a mm or so than the width of the slots nearest the eye. The slot vertical length is in the range 8 to 12 mm approximately. The distance between the front and rear ends of the slot is around 2 times the slot width, for example 14 to 20 mm. The advantage of the slots 8 compared with the holes of FIG. 1 is that the player has an uninterrupted view of the ball from it being held in the hand (viewed approximately straight ahead) to it being thrown up until the final moment of contact when serving (viewed upwards through the slots 8).

Because of the shielding by the material above, around and to the sides, a good level of protection is afforded against sunlight/bright floodlight that would otherwise enter the desired fields of view. In addition light that would not enter the desired field of view directly but could scatter or reflect off a spectacle frame or eyebrows or eyelashes and be nevertheless distracting to the wearer is also blocked. The rear surface of the main block 4, closest to the eyes of the wearer, is preferably made pale blue, white or another light colour to reduce the visual contrast between the view through the slots 8 and the surrounding opaque material. Another way of achieving a similar result would be to make the block 4 from a slightly translucent material that allows diffuse light to reach the rear surface.

In binocular viewing it is well known that some even well sighted individuals have a dominant eye and a non-dominant eye. When a target object is observed by such an individual the fixation point is governed by the dominant eye's visual direction. An individual is therefore likely to position his eyewear such that the dominant eye is well centred relative to its corresponding viewing hole. Although a small hole or small slot size is desirable for maximising glare reduction, the view seen by the non-dominant eye through its corresponding hole may appear distorted or in extreme cases the position of a ball may appear distorted or difficult to sight. One solution (not illustrated) is to increase the width of the slot 8 that corresponds to the non-dominant eye. In the FIGS. 2 and 2a, a prismatic element 9 is secured by screws 10 to corresponding threaded holes in the main block. Alternatively a recess can be provided in the main block 4 for the prism 9 to snap-fit into. The prismatic element provides horizontal optical power. The prismatic element 9 is placed over the non-dominant eye hole position, base in or base out depending on the sign of fixation insufficiency the wearer has. The prismatic element ensures that the visual direction of the non-dominant eye coincides with that of the dominant eye at the fixation point. To minimise bulk the prismatic element is made of a light, high refractive index material such as polycarbonate. Prismatic powers of up to 3 dioptres may be employed and this caters for most of the visual fixation differences and variations in the normal population. The optical power of the prismatic element is adjusted to an individual's eyes and fixation point insufficiency. Similarly all parameters hitherto mentioned will be set according to the individual wearer's eyes and anatomy.

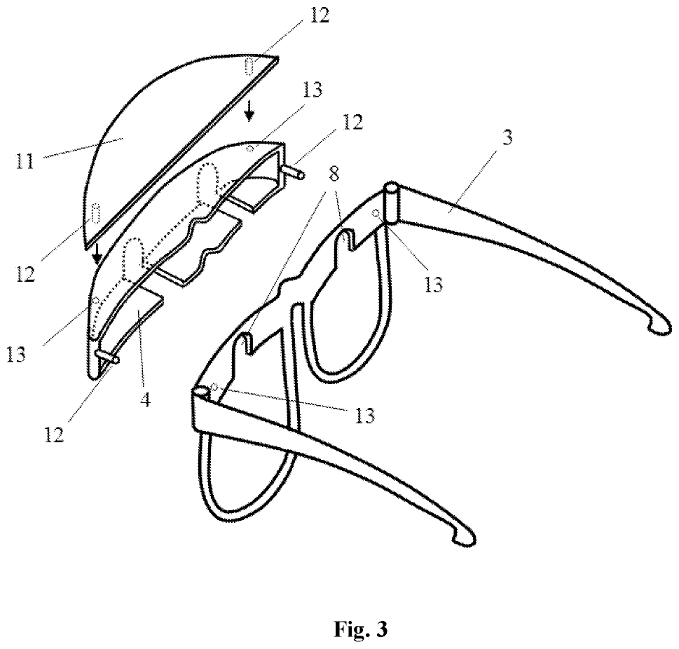

FIG. 3 shows a partial integration of the invention within a frame 3. Frame 3 is extended vertically to incorporate within it the slots 8. The wrap-around part of the frame 3 can also be similarly extended to provide side light shielding for the eyes. Main block 4 has crush pins 12 that can be permanently fixed to the frame 3 when the pins are engaged with corresponding holes 13 in the frame. Alternative fixing arrangements such as bayonet or snap fit fixings may be employed. Additional fixing may be provided on other points along the edges of the main block where they mate with the frame. These may provide permanent or removable fixings; such fixing methods are well known to those skilled in the art. An optional clip-on shade 11 is provided to further block downward bright light. A typical fixing arrangement to fix the shade 11 to the main block 4 is by crush pins 12 which engage with holes 13 in the top of the main block. For aesthetic reasons the frame 3, main block 4 and optional shade 11 are preferentially made from a material of the same colour, surface texture and surface finish.

Many well known methods of attaching eyewear devices to spectacles or the head exist and these are not claimed and are therefore not discussed in detail in the present invention.

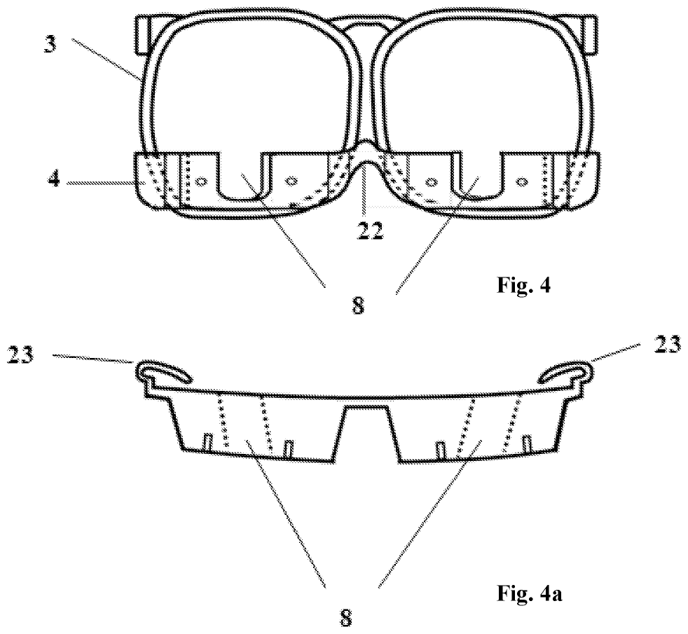

FIGS. 4 and 4a show an alternative arrangement of the main block 4 with cut-out areas 22 incorporated to accommodate the wearer's nose. The main block is attached to spectacle frame 3 by integral spring clips 23. Here the main difference from previous embodiments is that the main block 4 is positioned at the lower end of the spectacles. The fixing method is not claimed and many other mechanical fixing arrangements are possible. The fixing methods will be obviously be dependent on the shape and size of the spectacles. This embodiment is suitable for reducing glare in downhill skiing. Unlike racquet sports, in downhill skiing the desired fixation point F is normally many metres away from the skier. The angle subtended by the slot centre lines is adjusted to correspond to the increased fixation distance and will be typically 0.25 degrees or less.

An embodiment of the invention (not illustrated) that is suitable for use by motorists will have the main block 4 positioned slightly above the horizontal plane in order to shade the eyes from the glare of a brightly lit sky, while permitting a good degree of peripheral vision. Most vehicles have an enclosed cabin so the vertical field of view is limited by the roof of the car and it is not necessary for the slots 8 to extend vertically beyond the edge of the front windscreen as seen from a typical driving position. Overall, for driving applications the slots 8 may be lower and wider than for racquet sports without reduction in anti-glare performance. As with the skiing embodiment of FIG. 4, the axes of the slots 8 will have a small angle of convergence to allow the motorist to focus on the road many metres ahead.

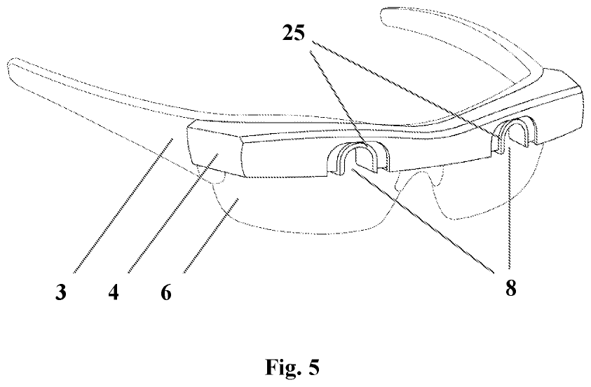

FIG. 5 shows a further embodiment of the invention in which the horizontal spacing between the slots 8 can be adjusted to match the interpupillary distance of the wearer's eyes. The two slots 8 are formed in respective elements 25 that are mounted for lateral movement relative to the block 4, for example by sliding within a chamber in the block 4. The two elements 25 may be interconnected to ensure that they remain symmetrical about the centreline of the eyewear. One way to do this would be for the elements 25 to carry respective ratchets (not shown) that engage with a common pinion (not shown) mounted at the centre of the block, so that they can move only in equal and opposite directions.

The components of the proposed sports eyewear will preferentially be made from a mouldable or cast plastic, metal or composite. Suitable frame materials include nylon, cellulose acetate and cellulose propionate; titanium, aluminium, beryllium and their alloys; and “memory metals” such as Flexon®.

In general, existing eyewear solutions to reduce glare from bright sunlight or other overhead sources, such as polarizing filters, gradient index filters and reflective filters, inevitably block light from a proportion of the desired the forward scene as well as block undesirable overhead sunlight rays. Because the proposed invention blocks a high proportion of rays from sun azimuth angles with highest irradiance that would otherwise reach the eye, the current invention in combination with such existing solutions enables a reduction of the filter attenuation in the forward desired viewing direction. Also in the case of a graduated filter, it enables the attenuation range low (for the forward scene direction) to high (unwanted ray directions) to be minimised. In the case of a graduated filter range where the attenuation is 0 to 10% in the forward scene direction and say 10 to 20% in the overhead, unwanted ray direction the demarcation between min to max attenuation would not be readily observable by eye. This in combination with the proposed invention would be an effective arrangement and provide glare reduction with minimal visual distraction to the wearer. The filter material may be provided as a continuous sheet that extends across both eyes and in this case it is possible to attach the main block 4 to the filter material rather than to the frame.

1. Eyewear comprising a shade (4) attached to a frame (3), the shade (4) being shaped and positioned not to obscure the field of view of a wearer when the wearer's gaze direction is straight ahead but to obscure the field of view of the wearer when the wearer's gaze direction is either upwards or downwards, except in two unobscured apertures (8), wherein:
the apertures (8) are formed as slots extending from an edge of the shade (4), whereby the view of the wearer is uninterrupted while the gaze direction moves between the straight ahead direction and the apertures (8);
each aperture (8) comprises a front opening and a rear opening in the shade (4), the front and rear openings defining a longitudinal axis (7) of the aperture (8); and
the longitudinal axes (7) of the two apertures (8) converge at a fixation point.

2. Eyewear according to claim 1, wherein the apertures (8) comprise areas of transparent or translucent material in the opaque material of the shade (4).

3. Eyewear according to claim 2, when the areas of transparent material are a graduated filter providing attenuation of 0% to 10% in the straight ahead direction and 10% to 20% in the apertures.

4. Eyewear according to claim 1, wherein the distance between the front and rear openings of each aperture (8) is at least 14 mm.

5. Eyewear according to claim 1, wherein the rear opening of each aperture (8) has a width of not less than 4 mm.

6. Eyewear according to claim 1, wherein the longitudinal axes (7) of the apertures (8) converge at an angle of between 1 and 5 degrees.

7. Eyewear according to claim 1, further comprising an optical element (9) that extends over one of the apertures (8) to provide horizontal optical power.

8. Eyewear according to claim 7, wherein the optical element (9) is a prismatic element.

9. Eyewear according to claim 1, wherein each aperture (8) is formed in a laterally movable element (25) of the shade (4), whereby the distance between the two apertures (8) is adjustable.
